(19) United States
(12) Patent Application Publication
(10) Pub. No.: US 2010/0313126 A1
(43) Pub. Date: Dec. 9, 2010

(54) METHOD AND APPARATUS FOR PROVIDING SELECTION AREA FOR TOUCH INTERFACE

(76) Inventors: Jong Woo JUNG, Seoul (KR); Young Wan Seo, Yongin-si (KR); In Sik Myung, Incheon Metropolitan City (KR); Sun Wha Chung, Yongin-si (KR); Joo Kyung Woo, Seoul (KR)

Correspondence Address: North Star Intellectual Property Law, PC, P.O. Box 34688, Washington, DC, 20043, US

(21) Appl. No.: 12/710,646

(22) Filed: Feb. 23, 2010

(30) Foreign Application Priority Data
Jun. 4, 2009 (KR) 10-2009-0049304

(51) Int. Cl. G06F 3/01

(52) U.S. Cl. 715/702; 715/769

(57) ABSTRACT

A method and an apparatus for providing a selection area for a touch interface are provided. A drag direction of a touch event may be sensed. When the drag direction of the touch event is changed, a selection area for a content may be provided based on a point where the drag direction is changed.

### CROSS-REFERENCE TO RELATED APPLICATION

This application claims the benefit under 35 U.S.C. §119(a) of a Korean Patent Application No. 10-2009-0049304, filed on Jun. 4, 2009, in the Korean Intellectual Property Office, the entire disclosure of which is incorporated herein by reference for all purposes.

### BACKGROUND

1. Field

The following description relates to a device including a touch interface, and more particularly, to an apparatus and method for providing a selection area on a touch interface that may be applicable to a mobile terminal and the like.

2. Description of Related Art

Recently, a touch interface has become widely used as a touch screen for a mobile terminal, for example, a smart phone. Through activation of the smart phone emphasizing a “PC in my hand,” users may do many things in a mobile environment. The users may perform functions easier and more efficiently using the touch interface.

The touch interface may have inconvenient and ineffective aspects. For example, in the case of a document creation, it may be difficult to input characters and select an accurate area using the touch interface in comparison to an existing key pad type interface.

### SUMMARY

In one general aspect, there is provided an apparatus for providing a selection area for a touch interface, the apparatus comprising a touch interface to display a content, a sensor to sense a touch event and a drag operation of the touch event via the touch interface, the touch event includes an initial point where the initial touch occurs, a change direction point where a drag direction is changed, and a finish point where the touch event is terminated, and a touch interface controller to control the touch interface to provide a selection area for the content based on a point where the drag direction is changed.

The selection area for the content may be set to an area from the point where the drag direction is changed to the finish point where the touch event is terminated.

The touch interface controller may control the touch interface to display an auxiliary image corresponding to a point where the touch event occurs.

The touch interface controller may control the touch interface to display an auxiliary image corresponding to a current touch point of a user.

The sensor may sense a touch event that occurs on different sides of the initial touch point, and the touch interface controller may select content from both of the different sides of the initial touch point.

The drag operation may include a first drag direction from the initial touch point to the change direction point, and a second drag direction from the change direction point to the finish point.

In another aspect, there is provided an apparatus for providing a selection area for a touch interface, the apparatus comprising a touch interface to display a content, a sensor to sense a touch event and a drag operation of the touch event via the touch interface, the touch event includes a starting point where the initial touch occurs, a change direction point where a drag direction is changed, and a finish point where the touch event is terminated, and a touch interface controller to control the touch interface to change a display attribute of the content based on a point where the drag direction is changed.

The touch interface controller may control the touch interface to change the display attribute of the content in an area from the point where the drag direction is changed to the finish point where the touch event is terminated.

The display attribute of the content may include at least one of a shadow, a font of a text, a color of the text, and a background color.

The touch interface controller may control the touch interface to display an auxiliary image corresponding to a point where the touch event occurs.

The touch interface controller may controls the touch interface to display an auxiliary image corresponding to a current touch point of a user.

The sensor may sense a touch event that occurs on different sides of the initial touch point, and the touch interface controller may select content from both of the different sides of the initial touch point.

The drag operation may include a first drag direction from the initial touch point to the change direction point, and a second drag direction from the change direction point to the finish point.

In another aspect, there is provided a method of providing a selection area for a touch interface, the method comprising displaying a content on the touch interface, sensing a touch event and a drag operation via the touch interface, the touch event includes a starting point where the initial touch occurs, a change direction point where a drag direction is changed, and a finish point where the touch event is terminated, and providing a selection area for the content based on a point where the drag direction is changed.

The selection area for the content may be set to an area from the point where the drag direction is changed to the finish point where the touch event is terminated.

The touch interface may display an auxiliary image corresponding to a point where the touch event occurs.

The touch interface may display an auxiliary image corresponding to a current touch point of a user.

The method may further comprise changing a display attribute of the selection area for the content.

The sensing may include sensing a touch event that occurs on different sides of the initial touch point, and the providing may include selecting content from both of the different sides of the initial touch point.

The drag operation may include a first drag direction from the initial touch point to the change direction point, and a second drag direction from the change direction point to the finish point.

Other features and aspects will be apparent from the following detailed description, the drawings, and the claims.

### BRIEF DESCRIPTION OF THE DRAWINGS

FIG. 1 is a diagram illustrating an apparatus for providing a selection area for a touch interface.

FIG. 2 is a flowchart illustrating an example of a method for providing a selection area for a touch interface.

FIG. 3 is a diagram illustrating an example of drag directions.

FIGS. 4 and 5 are diagrams illustrating examples of changing a drag direction.

FIGS. 6 and 7 are diagrams illustrating examples of highlighting a designated selection area by a user.

FIG. 8 is a diagram illustrating an example of a selection area for a content.

FIG. 9 is a diagram illustrating a conventional selection area for a content.

FIG. 10 is a diagram illustrating an example of a selection area for a content.

Throughout the drawings and the detailed description, unless otherwise described, the same drawing reference numerals will be understood to refer to the same elements, features, and structures. The relative size and description of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, description of well-known functions and constructions may be omitted for increased clarity and conciseness.

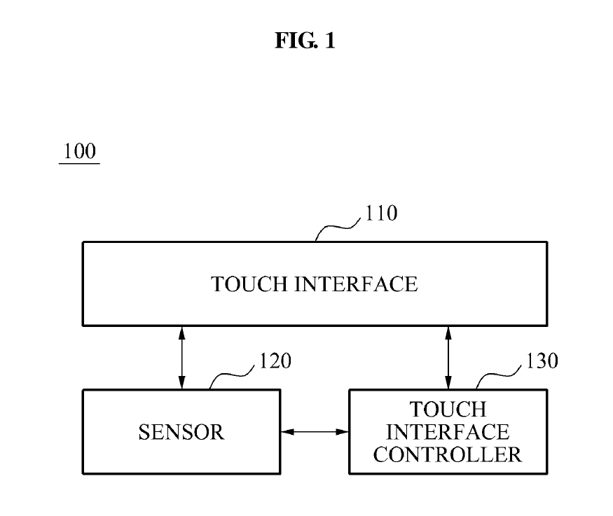

FIG. 1 illustrates an example of an apparatus for providing a selection area for a touch interface. Referring to FIG. 1, the selection area providing apparatus 100 includes a touch interface 110, a sensor 120, and a touch interface controller 130.

The touch interface 110 displays a content on the interface. The touch interface 110 provides a user interface that enables a user to input information by touch, for example, the user may input information via a user's finger, a stylus, and the like. Various applications may also be included in the selection area apparatus 100. For example, the selection area apparatus may include an application for a copy and paste function for the content, a webpage, a text file, and the like.

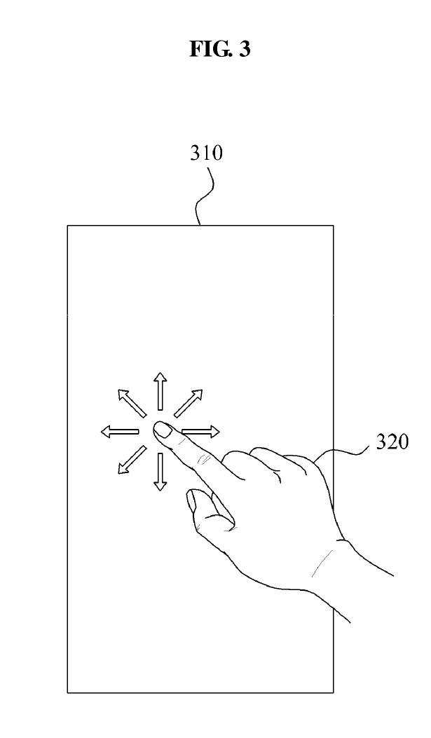

The sensor 120 senses a touch event on the touch interface 110, and may sense a drag direction of the touch event. For example, the touch event may indicate a state or an action where the user's finger, the stylus, and the like, touches the touch interface 110. The touch event includes a drag direction, for example, up, down, left, right, diagonal, or a combination thereof. The term “drag” used herein may be similar to a drag of a mouse in a PC environment. For example, a touch event may include a starting point, where the touch initially occurs, a change direction point where the drag direction is changed, and a finish point where the touch ends and the contact with the touch pad terminates. The drag operation may include dragging the touch from the starting point to the change direction point, and to the finish point. For example, a drag direction of the touch event may indicate a movement direction of the user's finger or the stylus in a state or action where the touch event is maintained. The drag direction of the touch event may be any desired direction, for example, up, down, left, right, a diagonal direction, or a combination thereof, as shown in FIG. 3.

The touch interface controller 130 performs various types of operations to provide the selection area and to control the selection area. The touch interface controller 130 may control the touch interface 110 to display the selection area for the content separately from other areas of the display.

Based on the drag direction of the touch event, the touch interface controller 130 may control the touch interface 110 to provide the selection area for the content. The selection area for the content may be set to an area from the point where the drag operation begins to a point where the touch event is terminated. The termination of the touch event denotes a state where the touch on the touch interface 110 is no longer sensed.

The drag direction of the touch event may be changed by the user. The touch interface controller 130 may control the touch interface 110 to change a display attribute of the content based on the change in the drag direction of the touch event. The touch interface controller 130 may control the touch interface 110 to change the display attribute of the content from the point where the drag direction of the touch event is changed to the point where the touch event is terminated. The display attribute of the content may include, for example, at least one of a shadow, a font of a text, a color of the text, a background color, and the like.

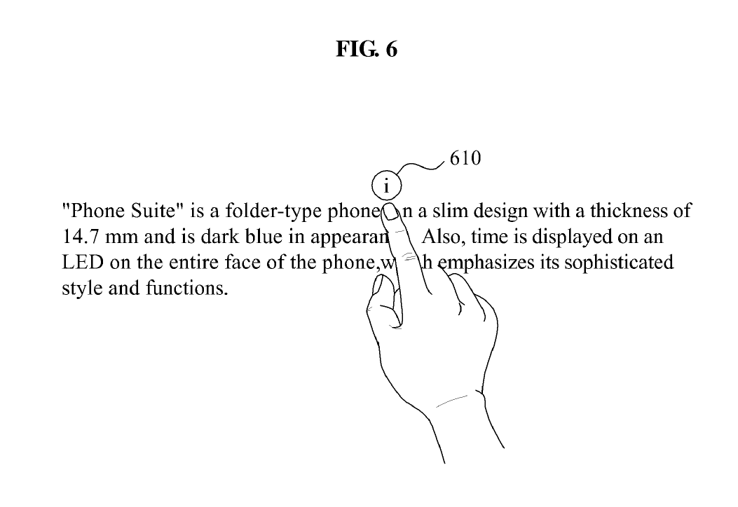

As shown in FIG. 6, the touch interface controller 130 may control the touch interface 110 to display an auxiliary image 610. The auxiliary image may corresponding to a point where an initial touch event occurs. The touch interface controller 130 may control the touch interface 110 to display an auxiliary image 610 corresponding to the current touch point of a user.

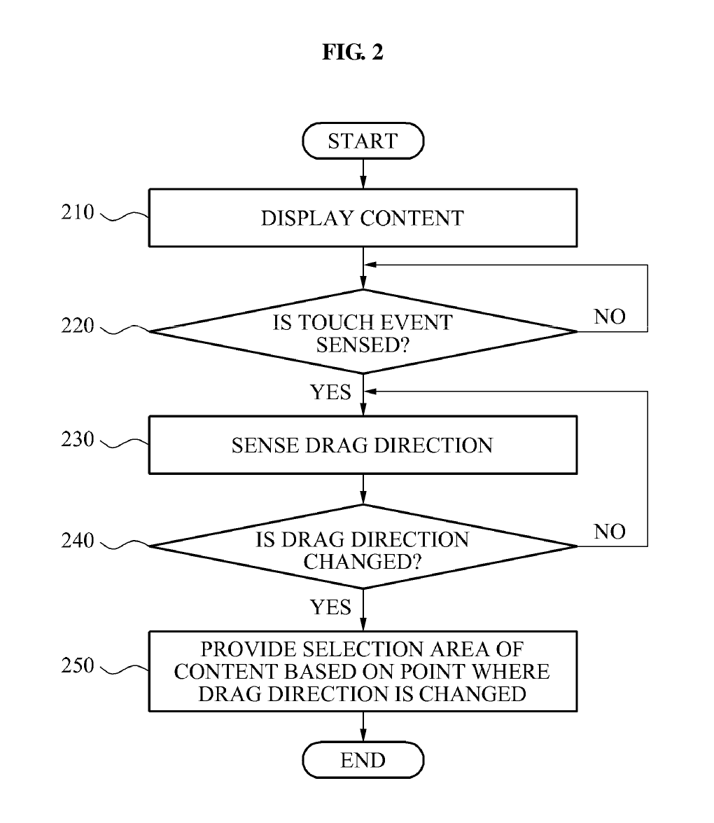

FIG. 2 illustrates an example of a method for providing a selection area for a touch interface. The selection area providing method may be performed by the selection area providing apparatus 100 illustrated in FIG. 1. The selection area providing method may also be performed by a processor embedded in a device to provide a touch interface. For this example, the selection area providing method is performed by the selection area providing apparatus 100.

Referring to FIG. 2, in 210, the selection area providing apparatus 100 displays a content on a touch interface.

In 220, the selection area providing apparatus 100 determines that a touch event is sensed on the touch interface and where on the interface the touch event is sensed. The sensing in 220 may be repeated to repeatedly sense whether a touch event occurs.

When a touch event is sensed, the selection area providing apparatus 100 senses a drag direction of the touch event, in 230. For example, as shown in FIG. 3, the drag direction may indicate a movement direction of a user's finger 320 in a state where the user's finger 320 touches a touch interface 310. For example, the drag direction may be up, down, left, right, diagonal, or a combination thereof. In some embodiments, a touch event may be performed by something other than a user's finger, for example, a stylus or other writing utensil.

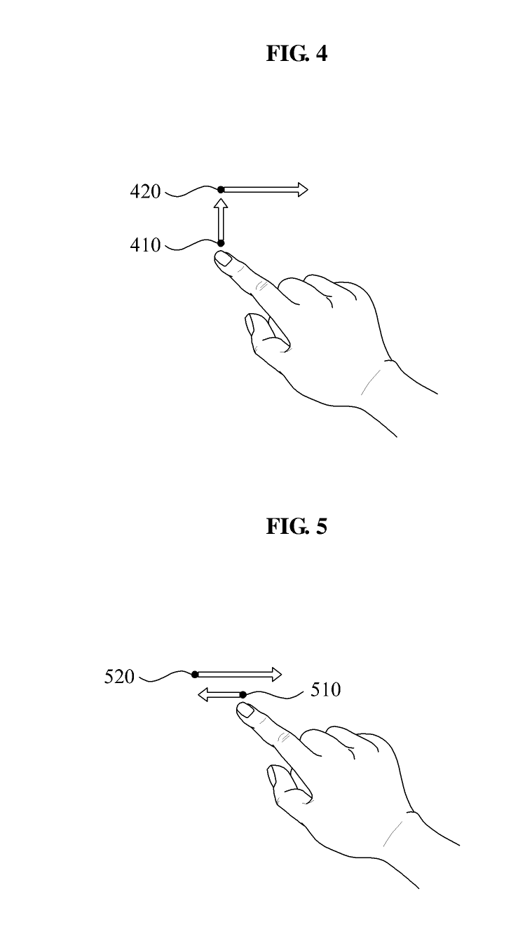

In 240, the selection area providing apparatus 100 senses whether the drag direction is changed. The sensing in 240 may be repeated to repeatedly sense whether a drag direction has changed. FIGS. 4 and 5 illustrate examples of changing a drag direction operation. Referring to FIG. 4, for example, the drag direction may be initially moving from a first point 410 where an initial touch event occurs to a second point 420. The drag direction may be subsequently changed by moving from the second point 420 towards the right of second point 420. Referring to FIG. 5, the drag direction may be changed, for example, by moving from a third point 510 where an initial touch event occurs to the left and subsequently moving from a second point 520 to the right. Examples of the drag direction are not limited to FIGS. 4 and 5. The drag direction may be changed at the desire of the user, and the direction may be changed from a first direction to a second direction. The first and second directions may be any of the possible drag directions. The drag direction may be changed from a first direction to a second direction. The second drag direction may be changed to a third drag direction.

When the drag direction is changed, in 250 the selection area providing apparatus 100 provides a selection area for the content based on the point where the drag direction is changed. The selection area for the content may be set to an area from the point where the drag direction is changed to a point where the touch event is terminated. The touch interface included in the selection area providing apparatus 100 may display an auxiliary image for a selection area designated by a user.

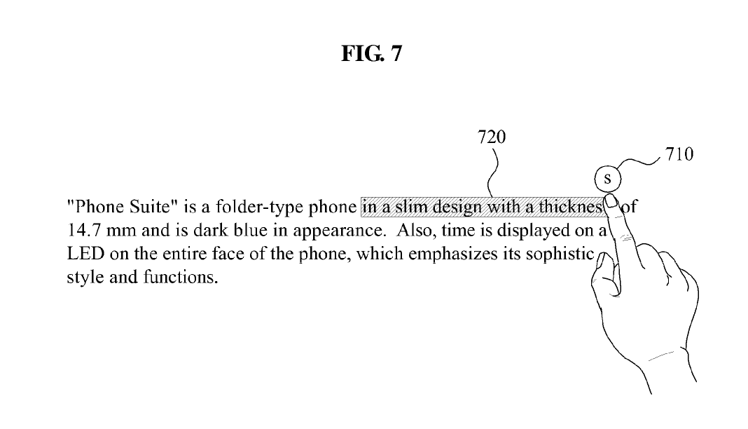

FIGS. 6 and 7 illustrate examples of highlighting a designated selection area by a user. Referring to FIG. 6, a touch interface may display an auxiliary image 610 corresponding to a point where an initial touch event occurs. The auxiliary image 610 may be displayed in a magnified form. The auxiliary image 610 may be displayed in a minimized form. An auxiliary image 610 may represent, for example, a current touch point of the user, a left portion of the current touch point, a right portion of the current touch point, or other desired area. The auxiliary image 610 may be displayed in various locations or sizes. For example, the touch interface may display, in a magnified form, an auxiliary image corresponding to the current touch point of the user. Referring to FIG. 7, the touch interface may display, in a magnified form, an auxiliary image 710 corresponding to a current touch point of the user where a selection area 720 is designated.

When the selection area providing apparatus 100 senses a first drag direction of a touch event and senses a second drag direction different from the first drag direction, the selection area providing apparatus 100 may change a display attribute of the content based on a starting point of the second drag direction. The selection area providing method may further include changing a display attribute of the designated selection area.

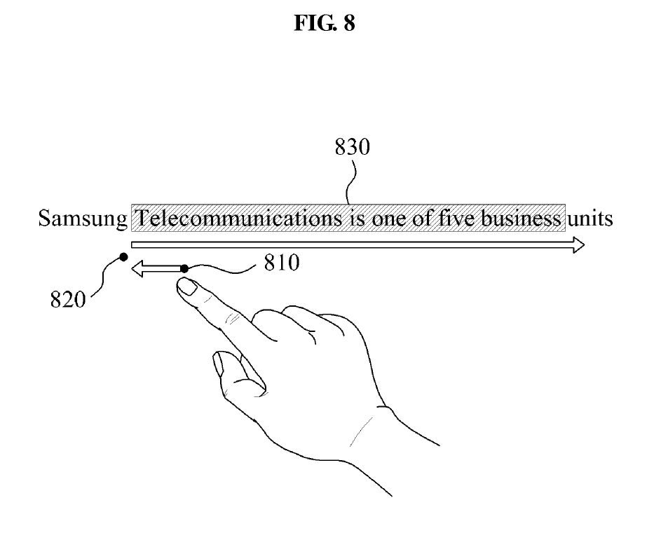

FIG. 8 illustrates an example selection area for a content. In this example, a user desires to designate/highlight the selection area that is “Telecommunications is one of five business.” In addition, for ease of description, the user's finger is positioned below the text in FIG. 8, in actuality the user's finger touches the interface.

For example, a user may touch an initial start point 810 of the content displayed on a touch interface and move the user's finger from the initial start point 810 to a desired point 820 in front of “Telecommunications.” In doing so the user performs an example of a drag operation. The user may designate a selection area 830 while dragging the user's finger from the point 820 towards the point 810. As described above, the selection area 830 may start from the point 820 where the drag direction is changed. Thus, a user may select content on multiple sides of an initial starting point.

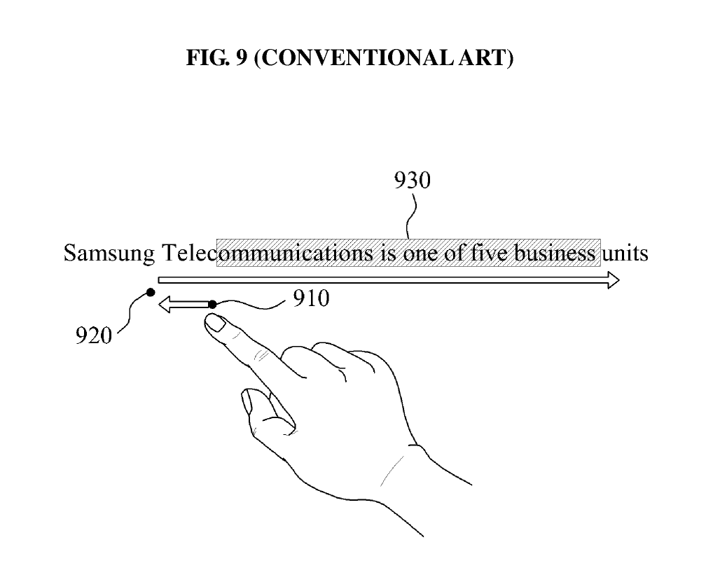

Hereinafter, a conventional selection area will be described with reference to FIG. 9 for comparison. FIG. 9 illustrates a conventional selection area 930 of a content.

Referring to FIG. 9, where an initial touch event occurs at a point 910 and a user drags the user's finger to a point 920 and then drags the user's finger from the point 920 towards the right, the selection area 930 for the content is designated as “communications is one of five business.”

Meanwhile, as shown in FIG. 8, when a user initially selects touch point 810, and performs a drag operation to point 820, the text “Tele” is selected. When the user performs the drag operation from point 820 toward the right, “Telecommunications is one of five business” is selected. That is, the selection area providing apparatus described herein allows a user to select text on different sides and in different directions from an initial touch point 810 through the use of multiple drag operations.

In the conventional method shown in FIG. 9, when a user initially selects touch point 910, and performs a drag operation to point 920, the text “Tele” is selected. However, when the user performs a drag operation from point 920 towards the right, and passes across and to the right of initial touch point 910, the highlighted field on the left side of initial touch point 910 is no longer selected. That is, the conventional method does not allow a user to change directions and cross back over an initial touch point and highlight content on both sides of the touch point. Instead, only content on one side of the initial touch point may be highlighted.

The apparatus and method described herein may allow a user the ability to more accurately designate selected text in an environment with a narrow touch interface. In the environment with the narrow touch interface such as a mobile device, it may be difficult for the user to accurately designate a desired initial touch point. For example, because a user's finger is often larger than text displayed on a mobile terminal, it may be difficult for a user to accurately select an initial touch point. However, using the selection area providing apparatus described herein, the user may easily move to the user's desired point using a drag function and thus may more accurately designate the selection area. An auxiliary image as shown in FIGS. 6 and 7 may help the user to find the user's desired point touch point. The user may drag a touch point to the user's desired location without a need to manipulate a separate button. Accordingly, it is possible to enhance the convenience of a user interface.

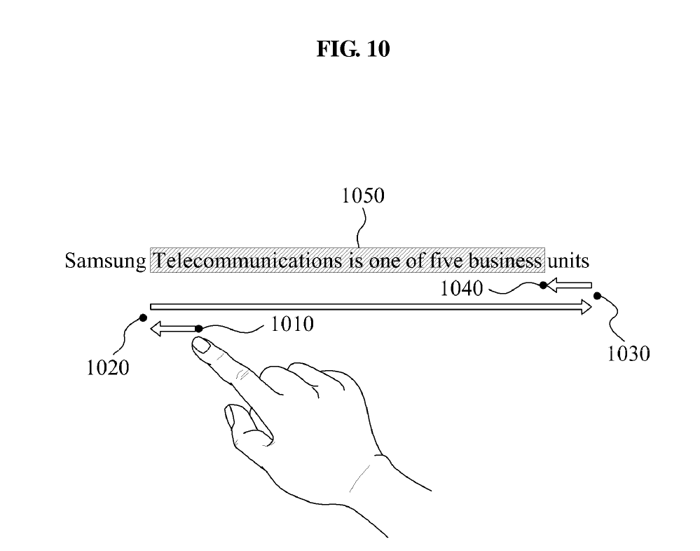

FIG. 10 illustrates an example selection area for a content. For ease of description, it is assumed that a user's finger is positioned below a text in FIG. 10, however, in actuality the user's finger touches the interface.

For example, a user may touch a random point 1010 of the content displayed on a touch interface and drag the user's finger from the point 1010 to a desired point 1020 in front of “Telecommunications.” In this example, the user desires to highlight the phrase “Telecommunications is one of five business.” The user may designate the selection area 1050 while dragging the user's finger from the point 1020 towards the point 1010. Next, the user may drag the user's finger from the point 1020 to a point 1030, beyond the desired content area that the user desires to select. The user may adjust the selection area 1050 by dragging the user's finger back to a point 1040. The user may confirm the selection area 1050 by separating the user's finger from the touch interface. Specifically, the selection area 1050 may be set to an area from the point 1020 where the drag direction is changed to the point 1040 where the touch event is terminated.

The selection area providing apparatus allows a user to more easily designate an accurate selection area using a touch interface. Also, it is possible to more easily and more accurately provide a user with a selection area in an environment where the user's controllable space is narrow, for example, on a mobile terminal. Further, if a user is having trouble viewing the text on the terminal, the interface touch apparatus may provide an auxiliary image to the user that magnifies the selection area.

As a non-exhaustive illustration only, the terminal device described herein may refer to mobile devices such as a cellular phone, a personal digital assistant (PDA), a digital camera, a portable game console, and an MP3 player, a portable/personal multimedia player (PMP), a handheld e-book, a portable lab-top PC, a global positioning system (GPS) navigation, and devices such as a desktop PC, a high definition television (HDTV), an optical disc player, a setup box, and the like capable of wireless communication or network communication consistent with that disclosed herein.

The processes, functions, methods and software described above including methods according to the above-described examples may be recorded in computer-readable storage media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa. In addition, a computer-readable storage medium may be distributed among computer systems connected through a network and computer-readable codes or program instructions may be stored and executed in a decentralized manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for providing a selection area for a touch interface, the apparatus comprising:
a touch interface to display a content;
a sensor to sense a touch event and a drag operation of the touch event via the touch interface, the touch event includes an initial point where the initial touch occurs, a change direction point where a drag direction is changed, and a finish point where the touch event is terminated; and
a touch interface controller to control the touch interface to provide a selection area for the content based on a point where the drag direction is changed.

2. The apparatus of claim 1, wherein the selection area for the content is set to an area from the point where the drag direction is changed to the finish point where the touch event is terminated.

3. The apparatus of claim 1, wherein the touch interface controller controls the touch interface to display an auxiliary image corresponding to a point where the touch event occurs.

4. The apparatus of claim 1, wherein the touch interface controller controls the touch interface to display an auxiliary image corresponding to a current touch point of a user.

5. The apparatus of claim 1, wherein the sensor senses a touch event that occurs on different sides of the initial touch point, and the touch interface controller selects content from both of the different sides of the initial touch point.

6. The apparatus of claim 1, wherein the drag operation includes a first drag direction from the initial touch point to the change direction point, and a second drag direction from the change direction point to the finish point.

7. An apparatus for providing a selection area for a touch interface, the apparatus comprising:
a touch interface to display a content;
a sensor to sense a touch event and a drag operation of the touch event via the touch interface, the touch event includes a starting point where the initial touch occurs, a change direction point where a drag direction is changed, and a finish point where the touch event is terminated; and
a touch interface controller to control the touch interface to change a display attribute of the content based on a point where the drag direction is changed.

8. The apparatus of claim 7, wherein the touch interface controller controls the touch interface to change the display attribute of the content in an area from the point where the drag direction is changed to the finish point where the touch event is terminated.

9. The apparatus of claim 7, wherein the display attribute of the content includes at least one of a shadow, a font of a text, a color of the text, and a background color.

10. The apparatus of claim 7, wherein the touch interface controller controls the touch interface to display an auxiliary image corresponding to a point where the touch event occurs.

11. The apparatus of claim 7, wherein the touch interface controller controls the touch interface to display an auxiliary image corresponding to a current touch point of a user.

12. The apparatus of claim 7, wherein the sensor senses a touch event that occurs on different sides of the initial touch point, and the touch interface controller selects content from both of the different sides of the initial touch point.

13. The apparatus of claim 7, wherein the drag operation includes a first drag direction from the initial touch point to the change direction point, and a second drag direction from the change direction point to the finish point.

14. A method of providing a selection area for a touch interface, the method comprising:
displaying a content on the touch interface;
sensing a touch event and a drag operation via the touch interface, the touch event includes a starting point where the initial touch occurs, a change direction point where a drag direction is changed, and a finish point where the touch event is terminated; and
providing a selection area for the content based on a point where the drag direction is changed.

15. The method of claim 14, wherein the selection area for the content is set to an area from the point where the drag direction is changed to the finish point where the touch event is terminated.

16. The method of claim 14, wherein the touch interface displays an auxiliary image corresponding to a point where the touch event occurs.

17. The method of claim 14, wherein the touch interface displays an auxiliary image corresponding to a current touch point of a user.

18. The method of claim 14, further comprising:
changing a display attribute of the selection area for the content.

19. The method of claim 14, wherein the sensing includes sensing a touch event that occurs on different sides of the initial touch point, and the providing includes selecting content from both of the different sides of the initial touch point.

20. The method of claim 14, wherein the drag operation includes a first drag direction from the initial touch point to the change direction point, and a second drag direction from the change direction point to the finish point.
